(19) United States
(12) Patent Application Publication
(10) Pub. No.: US 2015/0139427 A1
(43) Pub. Date: May 21, 2015

(54) SIGNAL PROCESSING APPARATUS, SIGNAL PROCESSING METHOD, PROGRAM, AND SPEAKER SYSTEM

(71) Applicant: Sony Corporation, Tokyo (JP)

(72) Inventor: Kazuki Sakai, Tokyo (JP)

(73) Assignee: Sony Corporation, Tokyo (JP)

(21) Appl. No.: 14/407,726

(22) PCT Filed: Jul. 17, 2013
(86) PCT No.: PCT/JP2013/069369

§ 371 Date: Dec. 12, 2014

(30) Foreign Application Priority Data
Jul. 19, 2012 (JP) 2012-160181

(51) Int. Cl. H04S 7/00; H04S 5/02

(52) U.S. Cl. CPC H04S 7/30; H04S 5/02
USPC 381/17

(57) ABSTRACT

Provided is a natural surround sound field balanced in volume in a multichannel surround reproduction environment, regardless of the positions of speakers actually disposed. Arrangement position information on real speakers is acquired. Based on the arrangement position information, a target position of a virtual speaker corresponding to a real speaker is set such that the virtual speaker is disposed in or near an ideal disposition area of the real speaker. The ideal disposition area of the real speaker is an area corresponding to the arrangement position of the speaker at the time of creation of a sound source. Based on the target position of the virtual speaker, the disposition of the virtual speaker is controlled.

### TECHNICAL FIELD

The present technology relates to signal processing apparatuses, signal processing methods, programs, and speaker systems, and more particularly, to signal processing apparatuses and others for adjusting acoustic characteristics of multichannel audio signals to be fed from a plurality of speakers.

### BACKGROUND ART

In order to precisely reproduce surround effects brought by multichannel audio signals, it is desired that distances from a listening position to speakers are all equidistant. ITU-R BS775-1 stipulates recommended angles of the speakers (hereinafter referred to as “ideal angles” as appropriate). However, when a plurality of speakers is arranged in an ordinary home, physical constraints arise from the shape of the house or the arrangement of furniture or the like, so that they cannot necessarily be arranged in positions equidistant from a listening position at ideal angles.

For example, Patent Document 1 describes performing calculations of distances to and angles of speakers by emitting a test signal from each speaker and collecting a response signal with a plurality of microphones placed in a listening position. Patent Document 1 also describes allowing a single output signal to be emitted from predetermined angles by correcting distances to the speakers through delay adjustments according to the distances and distributing the signal to a plurality of adjacent speakers.

### CITATION LIST

### Patent Document

Patent Document 1: Japanese Patent Application Laid-Open No. 2006-101248

### SUMMARY OF THE INVENTION

### Problems to be Solved by the Invention

In a technique described in above-described Patent Document 1, a speaker signal is properly distributed to adjacent speakers, according to a difference between a speaker placement angle and an ideal angle of the speaker, matching sound image localization of the signal with the ideal angle, thereby enabling the angle correction of the speaker. An ideal angle of a surround speaker is a value between 110 degrees and 130 degrees specified by ITU-R BS775-1, and is often an intermediate value of 120 degrees, for example. The value is often fixed.

However, simple signal distribution processing as described in above-described Patent Document 1 causes a virtual speaker to be disposed near a position on an axis connecting two speakers, so that the virtual speaker cannot be disposed in a position farther from a position on this axis.

For example, FIG. 17 illustrates a case where two surround speakers, a surround left speaker and a surround right speaker, are disposed almost rearward of a listening position. Consider a case where it is attempted to dispose a virtual speaker in a surround L ideal target position (c) by applying the above-described signal distribution processing to a front L speaker (a) and a surround L speaker (b) at equal distances. In this case, the virtual speaker is disposed not in the surround L ideal target position (c) but in a position (d) on an axis between the front L speaker (a) and the surround L speaker (b).

Consequently, an ideal sound field (e) is not provided, but a narrow-width sound field (f) is provided. When surround contents are listened in this sound field (f), narrowness of space in a lateral direction is perceived as a natural result. More signal components are reproduced from front three speakers than from the two surround speakers placed rearward, thus causing a significant defect that unnaturalness in front and rear volume balance is perceived.

An object of the present technology is to provide a natural surround sound field balanced in volume in a multichannel surround reproduction environment, regardless of the positions of speakers actually disposed.

### Solutions to Problems

A concept of the present technology lies in a signal processing apparatus including:

an arrangement position information acquisition unit for acquiring arrangement position information on a real speaker;

a target position setting unit for setting a target position of a virtual speaker corresponding to the real speaker, based on the acquired arrangement position information, such that the virtual speaker is disposed in or near an ideal disposition area of the real speaker; and

a disposition control unit for controlling the disposition of the virtual speaker, based on the set target position of the virtual speaker.

In the present technology, the arrangement position information acquisition unit acquires arrangement position information on a real speaker. The arrangement position information includes information showing the angle of the real speaker, and the like. For example, the arrangement information acquisition unit may be configured to acquire arrangement position information on a real speaker by collecting a test signal fed from the real speaker with two microphones spaced at a fixed distance and processing it.

Alternatively, for example, the arrangement information acquisition unit may be configured to read and acquire arrangement position information on a real speaker from a memory in which the arrangement position information is stored. Alternatively, for example, the arrangement information acquisition unit may be configured to acquire arrangement position information on a real speaker by an input operation of a user.

The target position setting unit sets a target position of a virtual speaker corresponding to the real speaker, based on acquired arrangement position information on the real speaker, such that the virtual speaker is disposed in or near an ideal disposition area of the real speaker. Here, the ideal disposition area of the real speaker is an area corresponding to the arrangement position of the speaker at the time of creation of a sound source. For example, the target position setting unit may be configured to set a target angle of the virtual speaker, based on a difference between an ideal target angle of the real speaker and an actual angle of the real speaker.

In this case, for example, the real speaker is a surround speaker, and the target position setting unit may be configured to use a first threshold value that is larger than the ideal angle of the real speaker and smaller than a maximum value of the target angle of the virtual speaker, and a second threshold value that is larger than the maximum value of the target angle of the virtual speaker, set the ideal target angle of the real speaker as the target angle of the virtual speaker when the actual angle of the real speaker is smaller than or equal to the first threshold value, set the maximum value of the target angle of the virtual speaker as the target angle of the virtual speaker when the actual angle of the real speaker is larger than the second threshold value, and set a corresponding angle in a range larger than the ideal target angle of the real speaker and smaller than or equal to the maximum value of the target angle of the virtual speaker, as the target angle of the virtual speaker, when the actual angle of the real speaker is in a range larger than the first threshold value and smaller than or equal to the second threshold value.

Further, in this case, for example, the real speaker is a front speaker, and the target position setting unit may be configured to use a first threshold value that is smaller than the ideal angle of the real speaker and larger than a minimum value of the target angle of the virtual speaker, and a second threshold value that is smaller than the minimum value of the target angle of the virtual speaker, set the ideal target angle of the real speaker as the target angle of the virtual speaker when the actual angle of the real speaker is larger than or equal to the first threshold value, set the minimum value of the target angle of the virtual speaker as the target angle of the virtual speaker when the actual angle of the real speaker is smaller than the second threshold value, and set a corresponding angle in a range smaller than the ideal target angle of the real speaker and larger than or equal to the minimum angle of the target angle of the virtual speaker, as the target angle of the virtual speaker, when the actual angle of the real speaker is in a range smaller than the first threshold value and larger than or equal to the second threshold value.

The disposition control unit controls the disposition of a virtual speaker, based on a set target position of the virtual speaker. For example, the disposition control unit may be configured to control the disposition of a virtual speaker by distributing an audio signal of a channel associated with a real speaker to the real speaker and a speaker adjacent to the real speaker, according to a set target angle of the virtual speaker.

Thus in the present technology, a target position of a virtual speaker is set based on arrangement position information on a real speaker, and the disposition of the virtual speaker is controlled based on this target position. Consequently, in a multichannel surround reproduction environment, a natural surround sound field balanced in volume can be provided, regardless of the positions of speakers actually disposed.

Further, a concept of the present technology lies in a speaker system including:

a plurality of speakers individually associated with a plurality of channels;

a signal distribution unit for distributing audio signals of the plurality of channels each to a speaker of an associated channel and a speaker of an adjacent channel;

a delay addition unit for adding delays to the audio signals to be fed to the plurality of speakers; and

a control unit for controlling operations of the signal distribution unit and the delay addition unit, based on information on actual arrangement positions of the plurality of speakers.

In the present technology, a plurality of speakers individually associated with a plurality of channels is provided. The signal distribution unit distributes audio signals of the plurality of channels each to a speaker of an associated channel and a speaker of an adjacent channel. The delay addition unit adds delays to audio signals to be fed to the plurality of speakers.

The control unit controls operations of the signal distribution unit and the delay addition unit, based on information on actual arrangement positions of the plurality of speakers. In this case, by controlling the operation of the signal distribution unit, a virtual speaker corresponding to each speaker is disposed in or near an ideal disposition area of the speaker. Further, by controlling the operation of the delay addition unit, the distances of all the speakers to a listening position are equalized. For example, the system may be configured to further include an arrangement position information acquisition unit for acquiring information on the actual arrangement positions of a plurality of speakers by collecting test signals fed from the plurality of speakers with two microphones spaced at a fixed distance and processing them.

For example, the control unit may be configured to set a target angle of a virtual speaker corresponding to a speaker of a predetermined channel, based on a difference between an ideal target angle of the speaker of the predetermined channel and an actual angle of the speaker of the predetermined channel, and control distribution of an audio signal of the channel associated with the speaker of the predetermined channel to the speaker of the predetermined channel and a speaker of an adjacent channel, according to the set target angle.

Thus in the present technology, the operations of the signal distribution unit and the delay addition unit are controlled, based on information on actual arrangement positions of a plurality of speakers, allowing provision of an excellent multichannel surround reproduction environment.

### Effects of the Invention

According to the present technology, in a multichannel surround reproduction environment, a natural surround sound field balanced in volume can be provided, regardless of the positions of speakers actually disposed.

### BRIEF DESCRIPTION OF DRAWINGS

FIG. 1 is a block diagram illustrating a configuration example of a multichannel reproduction system as an embodiment of the present technology.

FIG. 2 is a diagram illustrating a configuration example of an acoustic analysis block constituted by a DSP when an acoustic device is in an analysis phase.

FIG. 3 is a flowchart for illustrating a procedure of acoustic analysis processing in a controller constituting the acoustic analysis block.

FIG. 4 is a diagram for illustrating processing of acquiring arrangement position information with two microphones.

FIG. 5 is a diagram illustrating a specific example of speaker distance correction with delay parameters (delay times).

FIG. 6 is a diagram for illustrating a procedure of setting a surround target angle (target angle of a virtual speaker corresponding to a surround speaker).

FIG. 7 is a diagram for illustrating calculation of signal distribution parameters (distribution multipliers).

FIG. 8 is a diagram illustrating a configuration example of an acoustic adjustment block constituted by the DSP when the acoustic device is in a reproduction phase.

FIG. 9 is a diagram for illustrating a case where surround speakers are placed rearward in the present technology.

FIG. 10 is a diagram for illustrating a case where either of a surround left speaker and a surround right speaker is located rearward asymmetrically in a conventional art.

FIG. 11 is a diagram for illustrating a case where either of a surround left speaker and a surround right speaker is located rearward asymmetrically in the present technology.

FIG. 12 is a diagram for illustrating a case where a front left speaker and a front right speaker are disposed close to the center without a center speaker in a conventional art.

FIG. 13 is a diagram for illustrating a case where a front left speaker and a front right speaker are disposed close to the center without a center speaker in the present technology.

FIG. 14 is a diagram for illustrating a case where a front high speaker is disposed upward in a conventional art.

FIG. 15 is a diagram for illustrating a case where a front high speaker is disposed upward in the present technology.

FIG. 16 is a diagram for illustrating the fact that the present technology can be applied to a case where a plurality of speakers is handled as groups.

FIG. 17 is a diagram for illustrating a case where surround speakers are placed rearward in a conventional art.

### MODE FOR CARRYING OUT THE INVENTION

Hereinafter, a mode for carrying out the present technology (hereinafter, referred to as “embodiment”) will be described. Description will be made in the following order:

1. Embodiment

2. Modifications

### 1. EMBODIMENT

[Configuration Example of Multichannel Reproduction System]

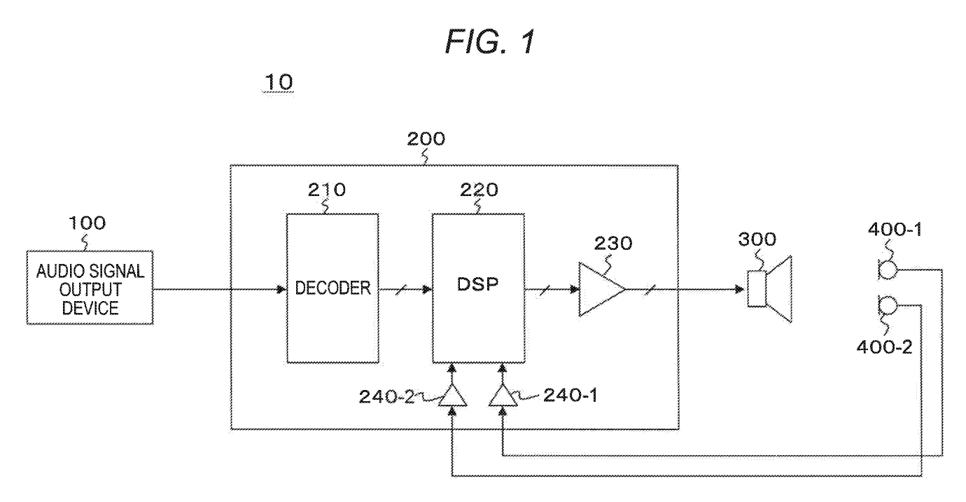

FIG. 1 shows a configuration example of a multichannel reproduction system 10 as an embodiment. The multichannel reproduction system 10 includes an audio signal output device 100, an acoustic device 200, a speaker 300, and microphones 400-1 and 400-2. The audio signal output device 100 is, for example, a DVD player or the like, and outputs 5.1-channel compressed audio signals in the Audio Code number 3 (AC-3) system.

The acoustic device 200 includes a decoder 210, a digital signal processor (DSP) 220, an amplifier 230, and amplifiers 240-1 and 240-2. The decoder 210 performs decoding processing on a compressed audio signal in the AC-3 system fed from the audio signal output device 100, and outputs an audio signal of each channel of the 5.1 channels. Here, audio signals of the channels are a front left signal, a front right signal, a center signal, a surround left (rear left) signal, a surround right (rear right) signal, and a subwoofer signal. In this embodiment, subwoofer signals are not used.

The DSP 220 constitutes an acoustic analysis block when the acoustic device 200 is in an analysis phase. The acoustic analysis block determines a filter parameter that is a coefficient value of a compensating filter for performing processing of phase adjustment and amplitude adjustment on an audio signal to be fed to each speaker. The acoustic analysis block also determines a signal distribution parameter for performing processing of distribution of an audio signal of each channel. Further, it determines a delay parameter for performing delay addition processing on an audio signal to be fed to each speaker. The detailed configuration of the acoustic analysis block will be described below.

Further, the DSP 220 constitutes an acoustic adjustment block when the acoustic device 200 is in a reproduction phase. The acoustic adjustment block performs processing of phase adjustment and amplitude adjustment on an audio signal to be fed to each speaker, using a filter parameter determined by the above-described acoustic analysis block, to match output acoustic characteristics of the speakers.

Further, the acoustic adjustment block performs processing of distributing an audio signal of each channel to a speaker associated with the channel and an adjacent speaker, based on a signal distribution parameter determined by the above-described acoustic analysis block, to control the disposition of a virtual speaker corresponding to a speaker of each channel. In this case, the control is performed such that a virtual speaker corresponding to a predetermined speaker is disposed in an ideal disposition area of the predetermined speaker or in the vicinity of it to provide a natural surround sound field balanced in volume, regardless of the positions of speakers actually disposed.

Further, the acoustic adjustment block performs processing of adding a delay to an audio signal to be fed to each speaker, based on a delay parameter determined by the above-described acoustic analysis block, to equalize the distances of all speakers to a listening position. The detailed configuration of the acoustic adjustment block will be described below.

The amplifier 230 amplifies a signal fed from the DSP 220 to the speaker 300. Specifically, when the acoustic device 200 is in the analysis phase, a test signal fed from the DSP 220 as the acoustic analysis block is amplified to be fed to the speaker 300. When the acoustic device 200 is in the reproduction phase, an audio signal fed from the DSP 220 as the acoustic adjustment block is amplified to be fed to the speaker 300. The amplifiers 240-1 and 240-2 amplify a response signal from the speaker 300 collected by the microphones 400-1 and 400-2 as described below and feed it to the DSP 220.

The speaker 300 is composed of a front left speaker, a front right speaker, a center speaker, a surround left (rear left) speaker, and a surround right (rear right) speaker. As described above, the DSP 220 determines signal distribution parameters, filter parameters, and delay parameters when constituting the acoustic analysis block. Also, as described above, the DSP 220 performs processing of phase adjustment and amplitude adjustment based on filter parameters, and performs processing of signal distribution and delay addition based on signal distribution parameters and delay parameters, when constituting the acoustic adjustment block.

The microphones 400-1 and 400-2 are disposed in the listening position for use when the acoustic device 200 is in the analysis phase. The microphones 400-1 and 400-2 collect a response signal from the speaker 300, and feed it to the DSP 220 as the acoustic analysis block.

The multichannel reproduction system 10 shown in FIG. 1 operates as described below when the acoustic device 200 is in the analysis phase and the DSP 220 constitutes the acoustic analysis block. In this case, a test signal is fed from the DSP 220. The test signal is amplified in the amplifier 230, and then fed from the speaker 300. The microphones 400-1 and 400-2 disposed in the listening position collect a response signal from the speaker 300. The response signal is fed to the DSP 220.

Based on the response signal, the DSP 220 determines a filter parameter for performing processing of phase adjustment and amplitude adjustment on an audio signal to be fed to each speaker. Based on the response signal, the acoustic analysis block determines a signal distribution parameter and a delay parameter for performing distribution processing of an audio signal associated with each speaker and delay addition processing on an audio signal to be fed to each speaker.

The multichannel reproduction system 10 shown in FIG. 1 operates as described below when the acoustic device 200 is in the reproduction phase and the DSP 220 constitutes the acoustic adjustment block. In this case, the audio signal output device 100 outputs a compressed audio signal in the AC-3 system of reproduction content. The compressed audio signal is fed to the decoder 210 of the acoustic device 200.

The decoder 210 performs decoding processing on the compressed audio signal in the AC-3 system to provide an audio signal of each channel of the 5.1 channels. The audio signal is fed to the DSP 220. On this audio signal, the DSP 220 performs processing of phase adjustment and amplitude adjustment, based on a filter parameter, and performs processing of signal distribution and delay addition, based on a signal distribution parameter and a delay parameter. The audio signal processed in the DSP 220 is amplified in the amplifier 230, and then fed from the speaker 300.

[DSP: Explanation of Acoustic Analysis Block]

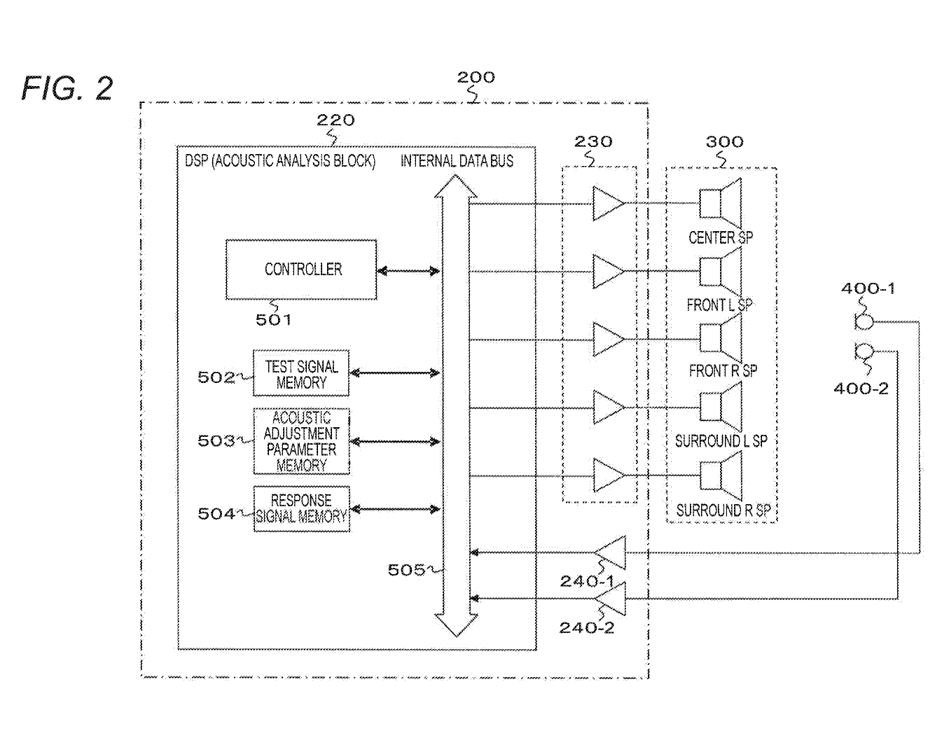

When the acoustic device 200 is in the analysis phase, the DSP 220 constitutes the acoustic analysis block as described above. FIG. 2 shows a configuration example of the DSP 220 in that case. In FIG. 2, portions corresponding to those in FIG. 1 are denoted by the same reference numerals.

In this case, the DSP 220 includes a controller 501, a test signal memory 502, an acoustic adjustment parameter memory 503, a response signal memory 504, and an internal data bus 505. The controller 501, the test signal memory 502, the acoustic adjustment parameter memory 503, and the response signal memory 504 are connected to the internal data bus 505.

The controller 501 controls an operation of each unit in the DSP 220 as the acoustic analysis block. The test signal memory 502 stores a test signal (impulse signal) to be fed from the speaker 300. The response signal memory 504 stores a response signal from the speaker 300 collected by the microphones 400-1 and 400-2.

The acoustic adjustment parameter memory 503 stores parameters determined in the analysis phase, that is, a signal distribution parameter, a filter parameter, and a delay parameter.

The controller 501 in the acoustic analysis block sequentially reads a test signal from the test signal memory 502, and outputs it from a target speaker. At the same time, it stores, in the response signal memory 504, a response signal from the speaker collected by the microphones 400-1 and 400-2 placed in the listening position. From then on, it sequentially outputs a test signal from all the speakers, and sequentially stores response signals to it in the response signal memory 504. Thereafter, the controller 501 sequentially calculates signal distribution parameters, filter parameters, and delay parameters, based on the response signals stored in the response signal memory 504, and stores them in the acoustic adjustment parameter memory 503.

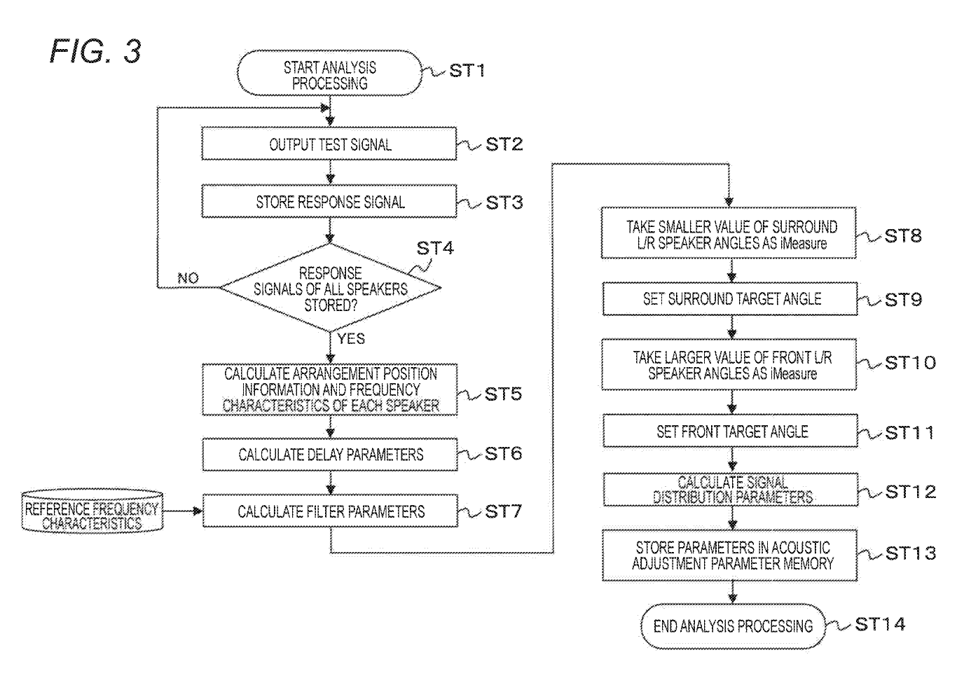

A flowchart in FIG. 3 shows a procedure of the acoustic analysis processing in the controller 501. In step ST1, the controller 501 starts analysis processing, and then proceeds to processing in step ST2. In step ST2, the controller 501 reads a test signal from the test signal memory 502, and outputs the test signal to a target speaker through the internal data bus 505 and the amplifier 230.

Next, in step ST3, the controller 501 receives a response signal from the target speaker collected by the microphones 400-1 and 400-2 through the internal data bus 505, and stores it in the response signal memory 504. At this time, as described below, it stores the times of arrival at the microphones together to calculate arrangement position information on the target speaker.

Next, in step ST4, the controller 501 determines whether response signals of all the speakers have been stored or not. When the controller 501 determines that response signals of all the speakers have not been stored, it returns to the processing in ST2, and repeats the same processing as described above with the next speaker as a target speaker. Here, all the speakers are the center speaker, the front left speaker, the front right speaker, the surround left speaker, and the surround right speaker included in the speaker 300.

When the controller 501 determines that response signals of all the speakers have been stored in step ST4, it performs calculations of arrangement position information on and frequency characteristics of the speakers in step ST5. The controller 501 sequentially takes each speaker as a target speaker, and calculates the frequency characteristics (phase characteristics and amplitude characteristics) of the target speaker by fast Fourier transform (FFT) analysis of the response signal from the target speaker.

Also, sequentially taking each speaker as a target speaker, the controller 501 calculates the arrangement position information on it. In this case, the controller 501 processes a response signal collected by the two microphones 400-1 and 400-2 from a target speaker to obtain arrangement position information on the target speaker (the angle of each speaker, the distance between each speaker and the listening position). At this time, the controller 501 uses the times of arrival of the response signal from the target speaker at the two microphones stored in above-described step ST3.

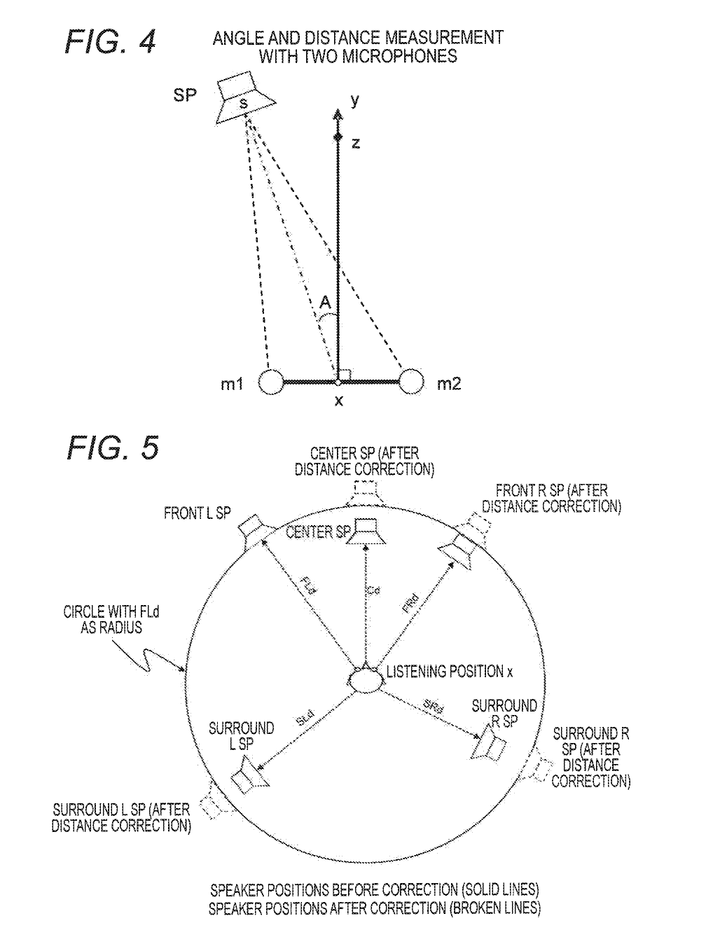

Referring to FIG. 4, arrangement position information acquisition processing with the two microphones will be described. A microphone 1 and a microphone 2 are placed in a listening position x at a known distance between the microphones (m1-m2). In this case, the microphone placement angle is adjusted such that the front direction of the microphones (x-z) agrees with the front direction of a listener (x-y).

The distance between a speaker SP and the microphone 1 (m1-s) and the distance between the speaker SP and the microphone 2 (m2-s) are calculated by emitting a test signal from the speaker SP and determining the times of arrival of the test signal at the microphone 1 and the microphone 2. A triangle (s-m1-m2) with three sides determined is uniquely identified, and all the three angles making the triangle are determined.

The listening position x is the midpoint of the distance between the microphones (m1-m2). By determining a side (m1-s), a side (m1-x), and an angle between them, a triangle (s-m1-x) is also uniquely identified, and the distance between the listening position and the speaker (x-s) is calculated. At the same time, the angle (A) of the speaker is calculated.

Returning to FIG. 3, after the processing in step ST5, the controller 501 proceeds to processing in step ST6. In step ST6, the controller 501 calculates a delay parameter. In this case, the controller 501 sequentially takes each speaker as a target speaker, and calculates a delay parameter to add a delay to an audio signal to be fed to the target speaker. At this time, the controller 501 calculates a delay parameter of each speaker, based on the distance between each speaker and the listening position calculated in step ST5.

In order to achieve precise surround effects, the distances between the speakers and the listening position are desirably the same distance. It is often difficult in an ordinary home to place all speakers necessary for multichannel audio reproduction equidistantly due to physical constraints of a room. In that case, by providing a proper delay to a signal to be fed to a speaker at a distance closer to a listening position, times of signals at the listening position can be matched to equalize the distances of all the speakers.

FIG. 5 shows a specific example of speaker distance correction. The arrangement of speakers before correction is shown by solid lines, and the positions of the speakers after correction are shown by broken lines. By the above-described processing of calculating the arrangement position information on the speakers in step ST5, the distances Cd, FLd, FRd, SLd, and SRd from a listening position x to the speakers, the center speaker, the front L speaker, the front R speaker, the surround L speaker, and the surround R speaker are each calculated.

The controller 501 calculates a delay time to be added to an audio signal to be fed to each speaker (delay parameter), with the greatest one of the distances of the speakers as MAXd, as described below. The velocity of sound is about 340 m/sec.

Center speaker signal delay time=(MAXd−Cd)/sound velocity

Front L speaker signal delay time=(MAXd−FLd)/sound velocity

Front R speaker signal delay time=(MAXd−FRd)/sound velocity

Surround L speaker signal delay time=(MAXd−SLd)/sound velocity

Surround R speaker signal delay time=(MAXd−SRd)/sound velocity

In FIG. 5, the FLd is the greatest distance, and thus the delay time of a signal fed to the front L speaker is zero. By setting the above-described delay times (delay parameters), signals emitted from the speakers arrive at the listening position x at the same time. This means that the speakers are arranged on a circle with the distance FLd as a radius, and the distances of all the speakers are equalized.

Returning to FIG. 3, after the processing in step ST6, the controller 501 proceeds to processing in step ST7. In step ST7, the controller 501 calculates filter parameters (phase filter parameters and amplitude filter parameters). In this case, the controller 501 sequentially takes each speaker as a target speaker, and calculates a filter parameter therefor.

In order to achieve precise surround effects, the frequency characteristics and gains of the speakers are desirably the same. When different types of speakers are mixed, or when being greatly susceptible to a reproduction environment such as reflected sound from walls, the frequency characteristics and gains of the speakers differ. In that case, it is necessary to use proper filters to equalize the frequency characteristics and gains of all the speakers.

In step ST7, the controller 501 calculates a difference between reference frequency characteristics and frequency characteristics determined by fast Fourier transform (FFT) analysis of a response signal from a target speaker. Then, it calculates a coefficient value of a compensating filter having the property of compensating for the difference as a filter parameter.

As frequency characteristics to be a reference, flat frequency characteristics, frequency characteristics of a particular speaker, frequency characteristics of the front speaker, or the like may be used. Since a response signal from each speaker is collected by the two microphones, two response signals are acquired for each. Either of the response signals, or an averaged response signal of them is used for calculating the frequency characteristics of the speaker.

Returning to FIG. 3, after the processing in step ST7, the controller 501 proceeds to processing in step ST8. In step ST8, the controller 501 takes a larger value of the angles of the surround L speaker and the surround R speaker calculated in step ST5 as an actual angle “iMeasure” of the surround speakers.

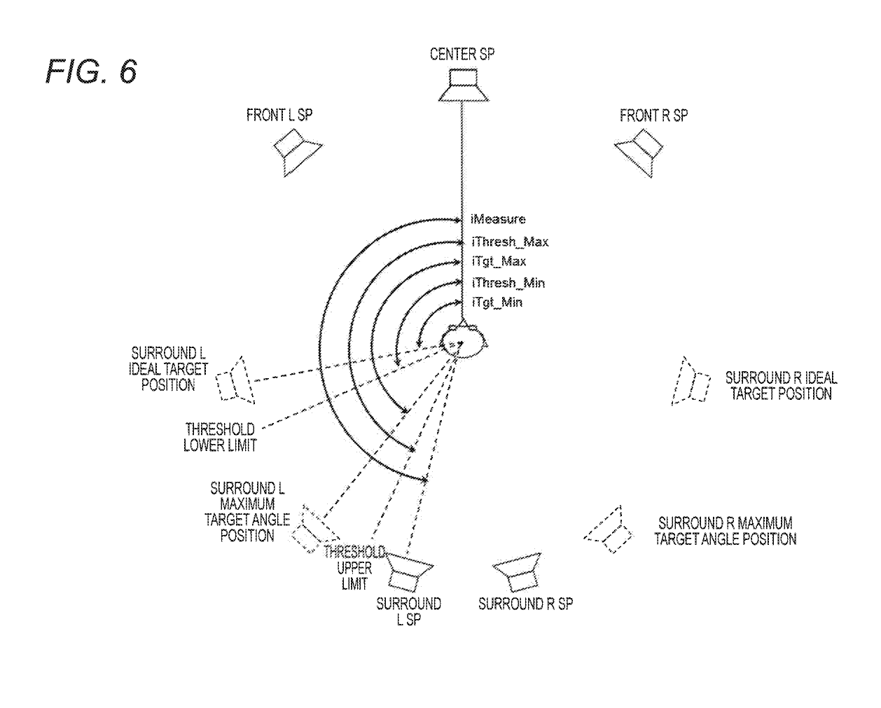

Next, in step ST9, the controller 501 sets a surround target angle, that is, a target angle of virtual speakers corresponding to the surround speakers. In this case, the controller 501 sets a target angle of the virtual speakers, based on a difference between an ideal target angle of the surround speakers and an actual angle of the surround speakers. Referring to FIG. 6, a procedure of setting the target angle will be described. Here, a surround ideal target angle (based on ITU-R) is “iTgt_Min,” a maximum value of a surround target angle is “iTgt_Max,” a threshold lower limit is “iThresh_Min,” a threshold upper limit is “iThresh_Max,” and the actual angle of the surround speakers is “iMeasure.”

The surround ideal target angle “iTgt_Min” is, for example, a value between 100 degrees and 120 degrees when based on “ITU-R BS775-1.” The maximum value “iTgt_Max” of the surround target angle is a maximum angle of angles that do not cause extreme unnaturalness in the arrangement of the surround speakers, and is a value between 130 degrees and 150 degrees resulting from adding degrees to the surround ideal target angle “iTgt_Min,” for example.

The threshold lower limit “iThresh_Min” is a value between the surround ideal target angle “iTgt_Min” and the maximum value “iTgt_Max” of the surround target angle. When the actual angle “iMeasure” of the surround speakers is smaller than or equal to this value, the surround target angle “iTgt” is set at “iTgt_Min” as described below. When the actual angle “iMeasure” of the surround speakers exceeds this value, the surround target angle “iTgt” is set at an angle between “iTgt_Min” and “iTgt_Max” as described below.

The threshold upper limit “iThresh_Max” is a value larger than the maximum value “iTgt_Max” of the surround target angle. When the actual angle “iMeasure” of the surround speakers exceeds this value, the surround target angle “iTgt” is set at “iTgt_Max” as described below. When the actual angle “iMeasure” of the surround speakers is smaller than or equal to this value, the surround target angle “iTgt” is set at a value between “iTgt_Min” and “iTgt_Max” as described below.

The controller 501 calculates a multiplier “fk” for setting the surround target angle. First, the maximum value “fmax” of “fk” is calculated, using the maximum value “iTgt_Max” of the surround target angle and the surround ideal target angle “iTgt_Min” as shown by the following expression (1):

fmax=iTgt_Max/iTgt_Min (1)

The controller 501 calculates the multiplier “fk” according to the actual angle “iMeasure” of the surround speakers as described below. Specifically, when “iMesure<=iThresh_Min,” “fk” is set at “1.0” as shown by the following expression (2):

fk=1.0 (2)

When “iMesure>iThresh_Max,” “fk” is set at “fmax” as shown by the following expression (3):

fk=fmax (3)

When “iThresh_Min<iMesure<=iThresh_Max,” “fk” is set at “fa*iMesure+fb” as shown by the following expression (4):

fk=fa*iMesure+fb (4)

Here, “fa” is expressed by the following expression (5), and “fb” is expressed by the following expression (6):

fa=(fmax−1.0)/(iThresh_Max−iThresh_Min) (5)

fb=1.0−fa*iThresh_Min (6)

As shown by the following expression (7), the controller 501 sets the surround ideal target angle “iTgt_Min” multiplied by “fk” as the surround target angle “iTgt.”

iTgt=iTgt_Min*fk (7)

In this manner, when the actual angle “iMeasure” of the surround speakers is smaller than or equal to the threshold lower limit “iThresh_Min,” the controller 501 sets the surround ideal target angle “iTgt_Min” as the surround target angle “iTgt.” When the actual angle “iMeasure” of the surround speakers is greater than the threshold upper limit “iThresh_Max,” the controller 501 sets the maximum value “iTgt_Max” of the surround target angle as the surround target angle “iTgt.”

When the actual angle “iMeasure” of the surround speakers is in a range larger than the threshold lower limit “iThresh_Min” and smaller than or equal to the threshold upper limit “iThresh_Max,” the controller 501 sets the surround target angle “iTgt” as described below. Specifically, at this time, the controller 501 sets a corresponding angle in the range larger than the surround ideal target angle “iTgt_Min” and smaller than or equal to the maximum value “iTgt_Max” of the surround target angle as the surround target angle “iTgt.”

With the surround target angle “iTgt” set in this manner, the surround target angle is properly set even when the surround speakers are placed rearward, allowing provision of a natural sound field.

Referring to FIG. 3, after the processing in step ST9, the controller 501 proceeds to processing in step ST10. In step ST10, the controller 501 sets a larger value of the angles of the front L speaker and the front R speaker calculated in step ST5 as the actual angle “iMeasure” of the front speakers.

Next, in step ST11, the controller 501 sets a front target angle, that is, a target angle of virtual speakers corresponding to the front speakers. In this case, the controller 501 sets the target angle of the virtual speakers, based on a difference between an ideal target angle of the front speakers and an actual angle of the front speakers. Here, a front ideal target angle (based on ITU-R) is “iTgt_Max,” a minimum value of the front target angle is “iTgt_Min,” a threshold lower limit is “iThresh_Min,” a threshold upper limit is “iThresh_Max,” and an actual angle of the front speakers is “iMeasure.”

The front ideal target angle “iTgt_Max” is, for example, 30 degrees when based on “ITU-R BS775-1.” The minimum value “iTgt_Min” of the front target angle is a minimum angle of angles that do not cause extreme unnaturalness in the arrangement of the front speakers, and is 24 degrees, for example.

The threshold lower limit “iThresh_Min” is a value smaller than the minimum value “iTgt_Min” of the front target angle. When the actual angle “iMeasure” of the front speakers is smaller than or equal to this value, the front target angle “iTgt” is set at “iTgt_Min” as described below. When the actual angle “iMeasure” of the front speakers exceeds this value, the front target angle “iTgt” is set at a value between “iTgt_Min” and “iTgt_Max” as described below.

The threshold upper limit “iThresh_Max” is a value between the minimum value “iTgt_Min” of the front target angle and the front ideal target angle “iTgt_Max”. When the actual angle “iMeasure” of the front speakers exceeds this value, the front target angle “iTgt” is set at “iTgt_Max” as described below. When the actual angle “iMeasure” of the front speakers is larger than or equal to this value, the front target angle “iTgt” is set at a value between “iTgt_Min” and “iTgt_Max” as described below.

The controller 501 calculates a multiplier “fk” for setting the front target angle. First, the minimum value “fmin” of “fk” is calculated, using the minimum value “iTgt_Min” of the front target angle and the front ideal target angle “iTgt_Max” as shown by the following expression (8):

fmin=iTgt_Min/iTgt_Max (8)

The controller 501 calculates the multiplier “fk” according to the actual angle “iMeasure” of the front speakers as described below. Specifically, when “iMesure<=iThresh_Min,” “fk” is set at “fmin” as shown by the following expression (9):

fk=fmin (9)

When “iMesure>iThresh_Max,” “fk” is set at “1.0” as shown by the following expression (10):

fk=1.0 (10)

When “iThresh_Min<iMesure<=iThresh_Max,” “fk” is set at “fa*iMesure+fb” as shown by the following expression (11):

fk=fa*iMesure+fb (11)

Here, “fa” is expressed by the following expression (12), and “fb” is expressed by the following expression (13):

fa=(1.0−fmin)/(iThresh_Max−iThresh_Min) (12)

fb=fmin−fa*iThresh_Min (13)

As shown by the following expression (14), the controller 501 sets the front ideal target angle “iTgt_Max” multiplied by “fk” as the surround target angle “iTgt.”

iTgt=iTgt_Max*fk (14)

In this manner, when the actual angle “iMeasure” of the front speakers is smaller than or equal to the threshold lower limit “iThresh_Min,” the controller 501 sets the minimum value “iTgt_Min” of the front target angle as the front target angle “iTgt.” When the actual angle “iMeasure” of the front speakers is larger than the threshold upper limit “iThresh_Max,” the controller 501 sets the front ideal target angle “iTgt_Max” as the front target angle “iTgt.”

When the actual angle “iMeasure” of the front speakers is in a range larger than the threshold lower limit “iThresh_Min” and smaller than or equal to the threshold upper limit “iThresh_Max,” the controller 501 sets the front target angle “iTgt” as described below. Specifically, at this time, the controller 501 sets a corresponding angle in the range larger than the minimum value “iTgt_Min” of the front target angle and smaller than or equal to the front ideal target angle “iTgt_Max” as the front target angle “iTgt.”

With the front target angle “iTgt” set in this manner, the front target angle is properly set even when the front speakers are placed closer to the center, allowing provision of a natural sound field.

In FIG. 3, after the processing in step ST11, the controller 501 proceeds to processing in step ST12. In step ST12, the controller 501 calculates signal distribution parameters. In this case, sequentially taking each speaker as a target speaker, the controller 501 calculates a signal distribution parameter for distributing an audio signal associated with the target speaker to the target speaker and a speaker adjacent to the target speaker. At this time, the controller 501 calculates a signal distribution parameter for each speaker, based on the target angle (speaker setting angle) of each speaker determined in step ST9 and step ST11.

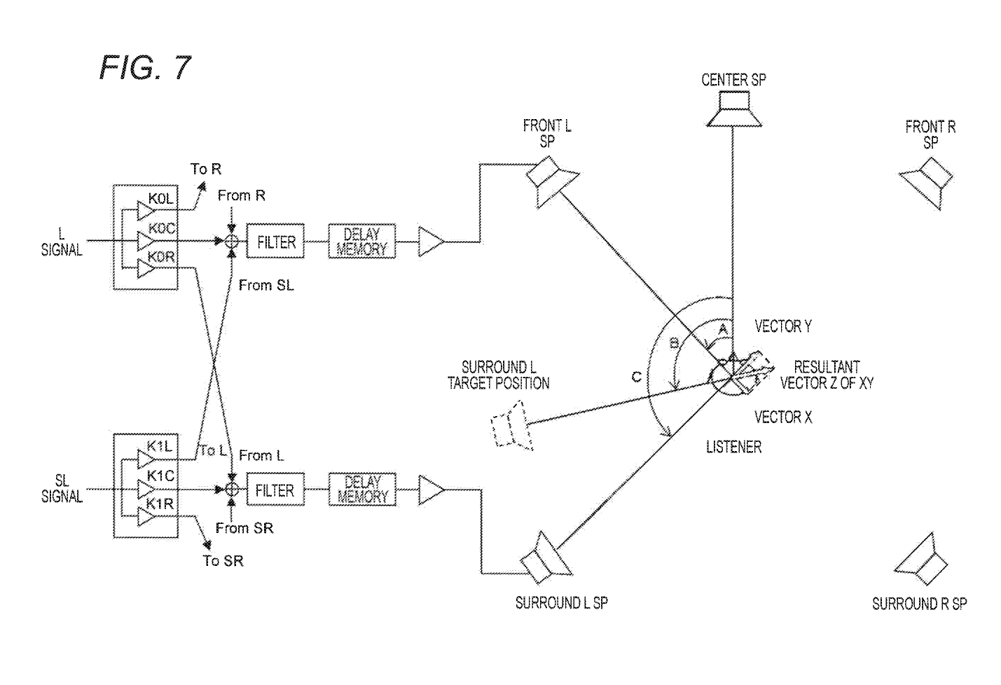

Referring to FIG. 7, calculation of a signal distribution parameter (distribution multiplier) will be described. FIG. 7 illustrates the signal distribution of a surround L signal. Depending on a setting angle A of the front L speaker, a target angle B of the surround L speaker, and an actual angle of the surround L speaker, the surround L signal needs to be distributed not only to the surround L speaker but also to the front L speaker properly to localize a sound image at a target position of the surround L speaker.

At this time, by setting a distribution multiplier KIL of the surround L signal in a signal distribution unit at the magnitude of vector X, and likewise a distribution multiplier KIC at the magnitude of vector Y, a sound image can be localized at a position corresponding to the resultant vector Z, that is, the target position of the surround L. Since the target position of the surround L speaker is located between the front L speaker and the surround L speaker, the signal is not distributed to the surround R speaker. Thus, a distribution multiplier K1R is set at zero.

A signal distribution parameter (distribution multiplier) for a signal other than the surround L signal can be calculated likewise, of which detailed description will not be made.

Referring to FIG. 3, after the processing in step ST12, the controller 501 proceeds to processing in step ST13. In step ST13, the controller 501 stores the delay parameters determined in step ST6, filter parameters determined in step ST7, and signal distribution parameters determined in step ST12 in the acoustic adjustment parameter memory 503. Thereafter, the controller 501 ends the analysis processing in step ST14.

[Explanation of DSP=Acoustic Adjustment Block]

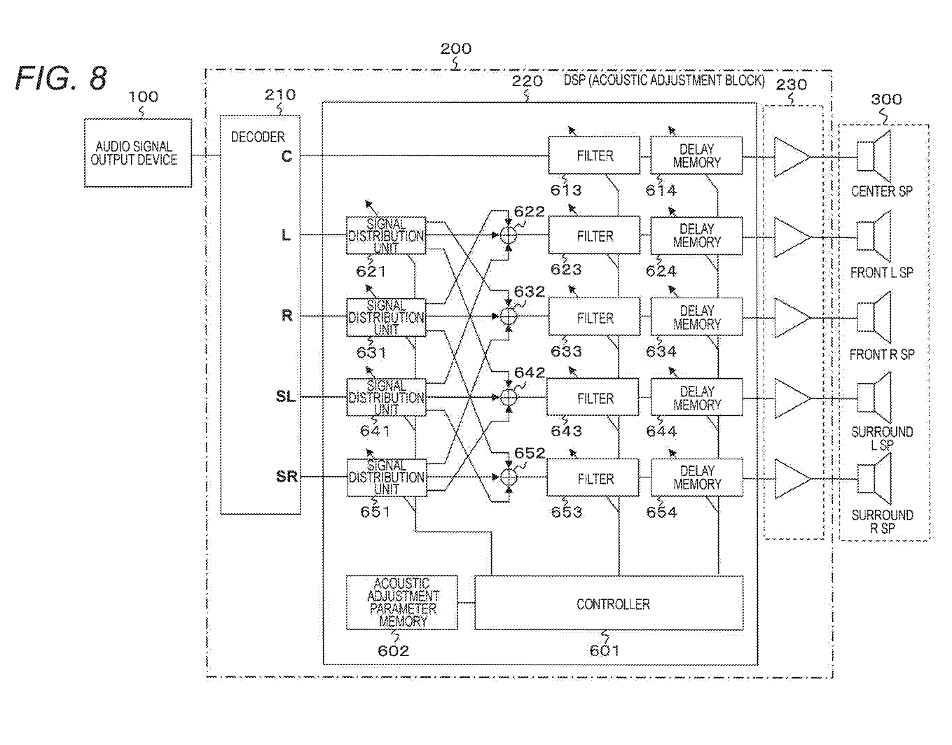

When the acoustic device 200 is in the reproduction phase, the DSP 220 constitutes the acoustic adjustment block as described above. FIG. 8 shows a configuration example of the DSP 220 in that case. In FIG. 8, portions corresponding to those in FIG. 1 are denoted by the same reference numerals. In this case, the DSP 220 includes a controller 601 and an acoustic adjustment parameter memory 602. The acoustic adjustment parameter memory 602 is the same as the acoustic adjustment parameter memory 503 in the above-described acoustic analysis block (see FIG. 2). The acoustic adjustment parameter memory 602 stores parameters (delay parameters, filter parameters, and signal distribution parameters) determined in the above-described acoustic analysis block.

The DSP 220 also includes a filter 613 for phase and amplitude adjustment, and a delay memory 614 for delay addition in an audio signal path of the center speaker (center SP). The DSP 220 also includes a filter 613 for phase and amplitude adjustment and a delay memory 624 for delay addition together with a signal distribution unit 621 and a synthesis unit 622 in an audio signal path of the front left speaker (front L SP). The signal distribution unit 621 distributes a front L signal to the front left speaker and an adjacent speaker. The synthesis unit 622 synthesizes an audio signal of its own channel with an audio signal of an adjacent channel.

The DSP 220 also includes identical circuits in audio signal paths of the front right speaker (front R SP), the surround left speaker (surround L SP), and the surround right speaker (surround R SP). Specifically, it includes a signal distribution unit 631, a synthesis unit 632 filter, a filter 633, and a delay memory 634 in an audio signal path of the front right speaker (front R SP).

The DSP 220 also includes a signal distribution unit 641, a synthesis unit 642 filter, a filter 643, and a delay memory 644 in an audio signal path of the surround left speaker (surround L SP. The DSP 220 also includes a signal distribution unit 651, a synthesis unit 652 filter, a filter 653, and a delay memory 654 in an audio signal path of the surround right speaker (surround R SP.

The controller 601 controls an operation of each unit in the DSP 220 as the acoustic adjustment block. The controller 601 reads signal distribution parameters, filter parameters, and delay parameters of the speakers stored in the acoustic adjustment parameter memory 602 to set them in the signal distribution units, the filters, and the delay memories located in the respective audio signal paths.

The signal distribution units 621, 631, 641, and 651 distribute audio signals of the channels to the speakers of the individually associated channels and adjacent speakers, according to the set signal distribution parameters. The synthesis units 621, 631, 641, and 651 synthesize audio signals of their own channels with audio signals of adjacent channels. The functions of these signal distribution units and synthesis units allow virtual speakers individually corresponding to the front speakers and the surround speakers to be disposed in the respective set target angle positions.

The filters 613, 623, 633, 643, and 653 adjust frequency characteristics of audio signals to be fed to the speakers of the associated channels, according to the set filter parameters. The delay memories 614, 624, 634, 644, and 654 add delays to audio signals to be fed to the speakers, according to the set delay parameters.

The DSP 220 as the acoustic adjustment block shown in FIG. 8 performs acoustic adjustment on an audio signal of each channel. Specifically, a center signal among audio signals of the channels fed from the decoder 210 is subjected to the processing by the filter 613 and the delay memory 614, passes through the amplifier 230, and is fed from the center speaker. Signals other than a center signal among audio signals of the channels fed from the decoder 210 are subjected to the processing by the signal distribution units, the synthesis units, the filters, and the delay memories, pass through the amplifier 230, and are fed from the speakers.

In the acoustic adjustment block shown in FIG. 8, the functions of the signal distribution units and the synthesis units allow virtual speakers individually corresponding to the front speakers and surround speakers to be disposed in the respective set target angle positions. Further, the function of the filters allows output acoustic characteristics of the speakers to be matched. Moreover, the function of the delay memories allows the distances of all the speakers to the listening position to be equalized. Consequently, natural surround effects can be offered to the listener.

For example, when surround speakers are placed rearward, the arrangement of virtual surround speakers are controlled with a surround ideal angle directly set as a surround target angle in a conventional art, thus resulting in an unnatural surround sound field imbalanced in front and rear volume (see FIG. 17). In contrast, in this embodiment, a surround target angle is set according to an actual angle of surround speakers to control the arrangement of virtual surround speakers. Therefore, even when surround speakers are placed rearward, a surround target angle is set properly, thus allowing provision of a natural sound field.

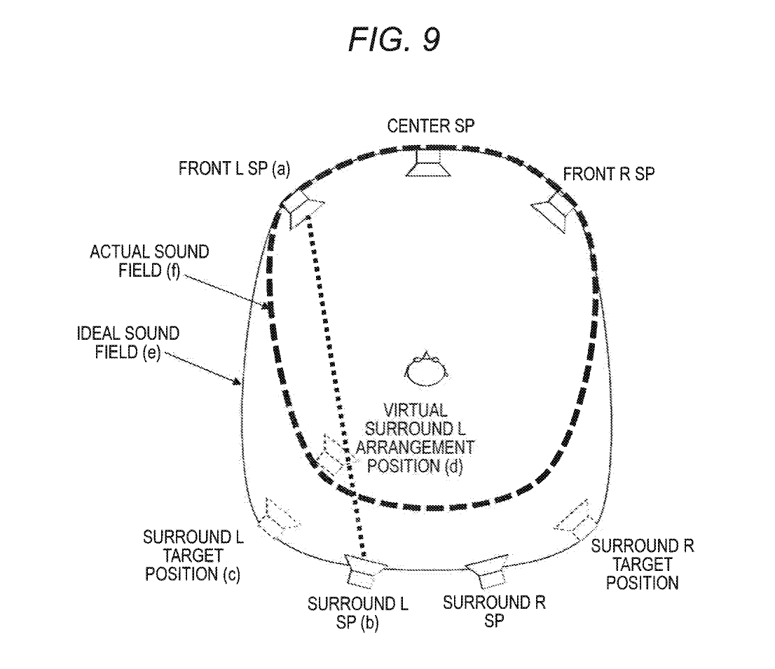

In this embodiment, as shown in FIG. 9, a surround L target position (c) is changed rearward according to the angle of a surround speaker L (b). Therefore, when signal distribution processing is applied to a front L speaker (a) and a surround L speaker (b) that are equidistant to dispose a virtual speaker in the surround L target position (c), an arrangement position (d) of the virtual speaker also moves rearward. As a result, a sound field (f) reproduced is narrow in width, but is extended greatly rearward. Consequently, a front and rear volume balance is improved, and the unnaturalness can be solved.

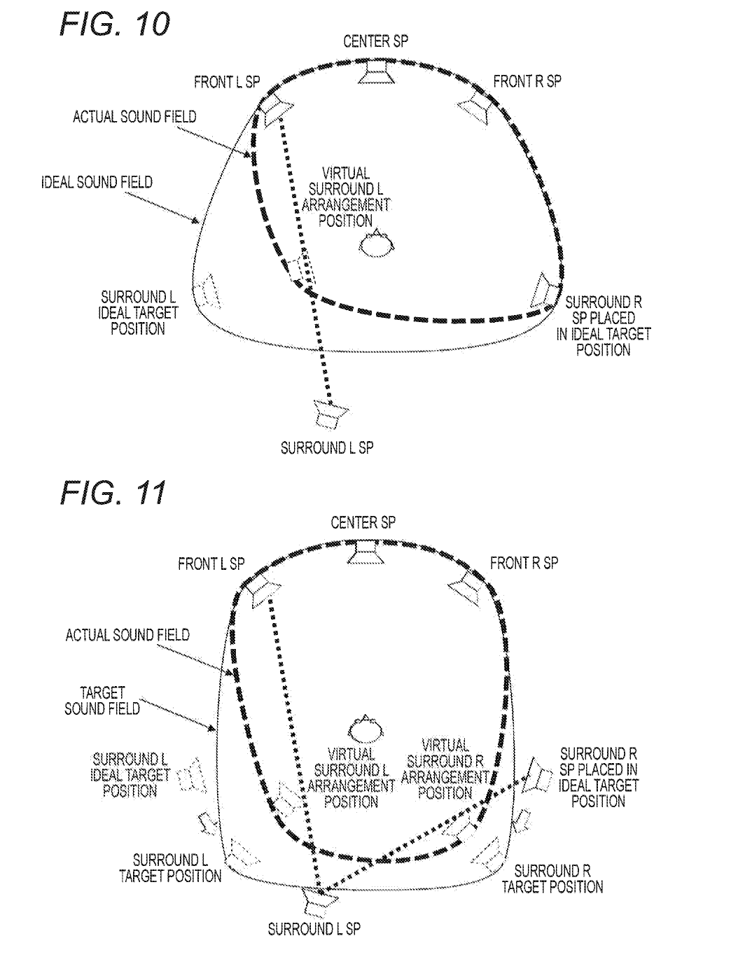

Further, this embodiment can also cope well with the case where either of a surround left speaker and a surround right speaker is located rearward asymmetrically. FIG. 10 shows a case where a conventional art is applied. In this example, a surround L speaker is disposed greatly rearward, and a surround R speaker is disposed in an ideal target position. Even though a signal of the surround L speaker is distributed between the front L speaker and the surround L speaker for disposition in an ideal target, in practice, a virtual surround L speaker is disposed on an axis line between the front speaker L and the surround speaker L. This results in a left-right asymmetrical unnatural sound field imbalanced in front and rear volume.

FIG. 11 shows a case of this embodiment. In this case, target positions of surround speakers are changed rearward from ideal target positions. Consequently, the balance between left and right and front and rear volume is improved. In this case, although the disposition angle of the surround speakers is somewhat rearward compared with the ideal target angle, an increase in the volume from the rear enlarges a reproduction sound field, resulting in a natural sound field.

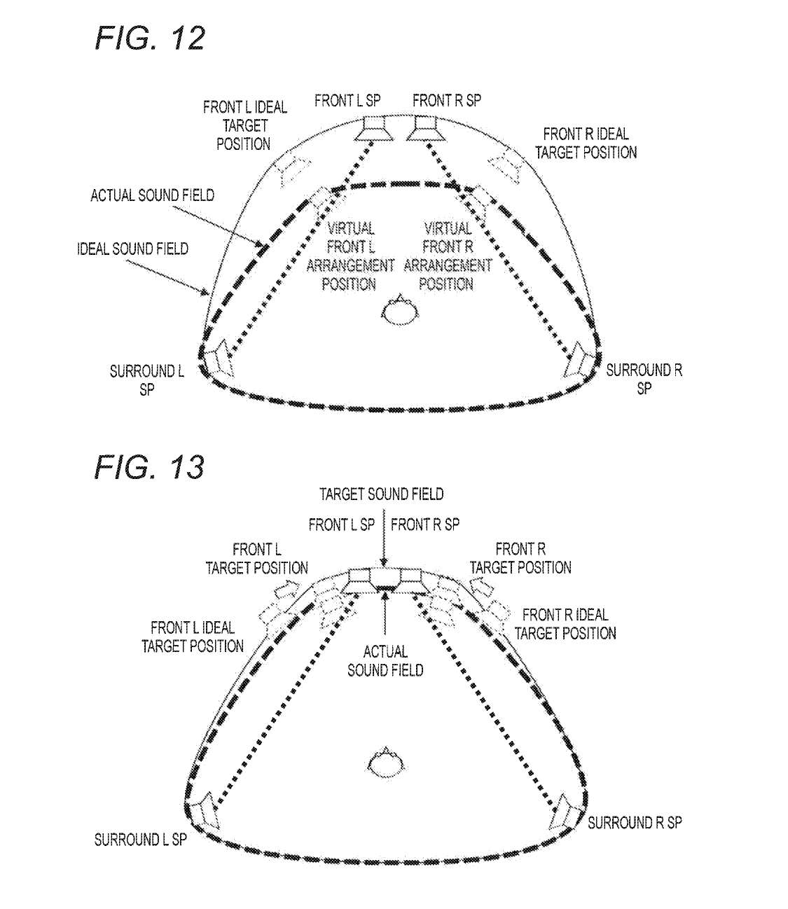

Further, this embodiment can well cope with the case where a front left speaker and a front right speaker are disposed closer to the center without a center speaker. FIG. 12 shows a case where a conventional art is applied. When it is attempted to dispose virtual speakers in ideal target positions (front±30 degrees) of front speakers, in practice, the virtual front speakers are disposed on axis lines between the front speakers and surround speakers. Many of front signal components are distributed to the surround speakers, thus resulting in a sound field imbalanced in front and rear volume as in a thick dotted line.

FIG. 13 shows a case of this embodiment. In this case, target positions of front speakers are set closer to the front. Consequently, the front and rear volume balance is improved. In this case, although the disposition angle of the front speakers is somewhat narrowed compared with an ideal target angle, an increase in the volume from the front enlarges a reproduction sound field, resulting in a more natural, sound field.

As described above, in the multichannel reproduction system 10 shown in FIG. 1, a target angle of a virtual speaker is set based on an actual angle of a real speaker (front speaker, surround speaker), and the disposition of the virtual speaker is controlled based on this target angle. Consequently, in a multichannel surround reproduction environment, a natural surround sound field balanced in volume can be provided, regardless of the positions of speakers actually disposed.

### 2. MODIFICATIONS

Although in the above-described embodiment, an example of controlling the disposition of virtual speakers corresponding to front speakers and surround speakers constituting the multichannel reproduction system 10 has been illustrated, the present technology can likewise be applied to a case where in a multichannel reproduction system that further includes a front high speaker, the disposition of a virtual speaker corresponding to the front high speaker is controlled.

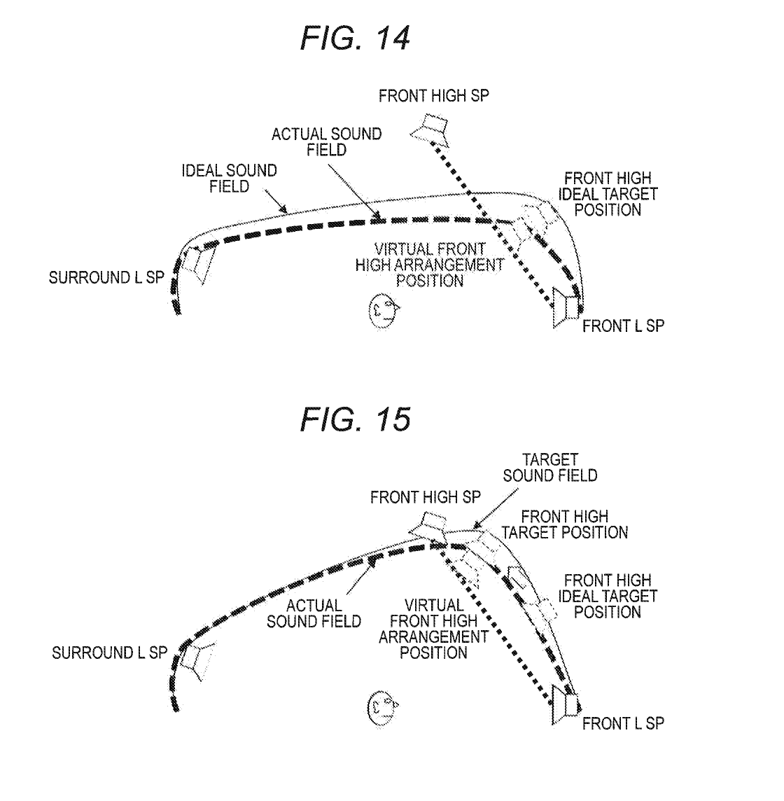

FIG. 14 illustrates a case where a conventional art is applied. In a case where a front high speaker is disposed upward, even though it is attempted to dispose a virtual speaker in an ideal target position of the front high speaker by signal distribution processing, in practice, the virtual front high speaker is disposed on an axis line between a front speaker and the front high speaker. This results in a sound field imbalanced in upper and lower volume.

FIG. 15 illustrates a case where the present technology is applied. In this case, a target position of a front high speaker is set upward. Consequently, the upper and lower volume balance is improved. In this case, although a disposition angle of the front high speaker is somewhat widened compared with an ideal target angle, an increase in the volume from above enlarges a reproduction sound field.

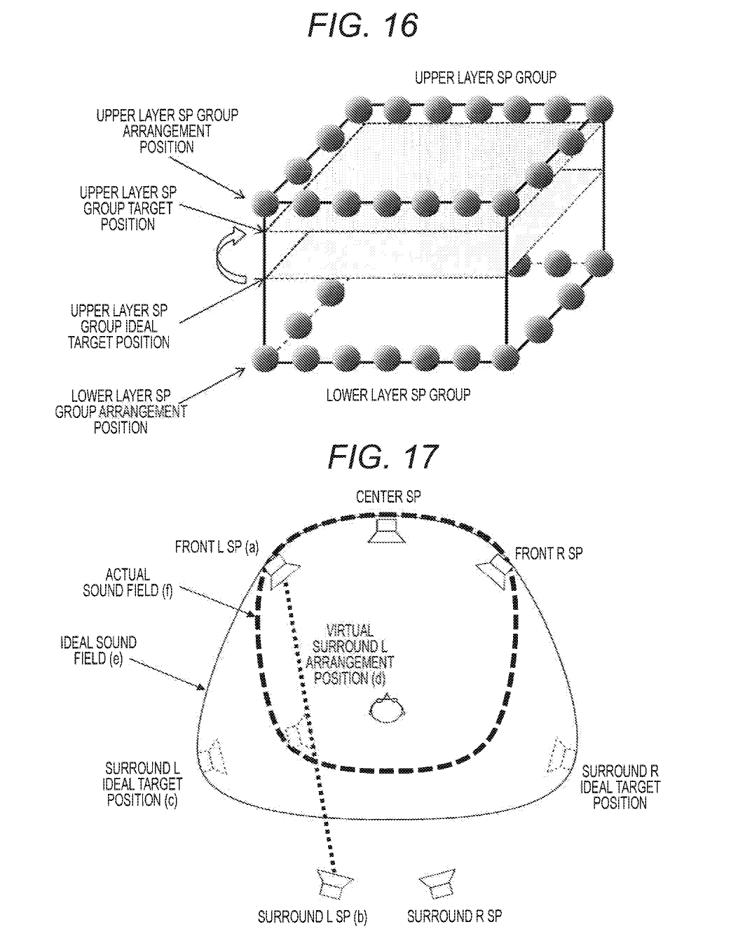

In the above-described example, an example of controlling the disposition of a virtual speaker corresponding to a single speaker is shown. However, the present technology can likewise be applied to a case where a plurality of speakers is handled as a group as shown in FIG. 16. An example illustrated shows an example in which a plurality of real speakers is disposed in space as a lower layer speaker group and an upper layer speaker group. In this case, when it is determined that the arrangement position of the actually disposed upper layer speaker group is upward compared with an ideal target position of the upper layer speaker group, a target position of the upper layer speaker group is set upward, according to the arrangement position. As a result, the upward and downward volume balance becomes natural.

In the above-described embodiment, an example of collecting a test signal fed from each speaker by the two microphones 400-1 and 400-2 spaced at a fixed distance and processing it to acquire arrangement position information on each speaker has been illustrated. However, for example, it is also possible to read and acquire this arrangement position information from a memory in which the arrangement position information on each speaker is stored. Alternatively, for example, it is also possible to acquire arrangement position information on each speaker by an input operation of a user.

In the above-described embodiment, an example of the multichannel reproduction system 10 that handles 5.1-channel audio signals has been shown. The present technology can likewise be applied also to a multichannel reproduction system that handles other multichannel audio signals such as 7.1-channel ones, as a matter of course.

The present technology can also take configurations as below.

(1) A signal processing apparatus including:

an arrangement position information acquisition unit for acquiring arrangement position information on a real speaker;

a target position setting unit for setting a target position of a virtual speaker corresponding to the real speaker, based on the acquired arrangement position information, such that the virtual speaker is disposed in or near an ideal disposition area of the real speaker; and

a disposition control unit for controlling the disposition of the virtual speaker, based on the set target position of the virtual speaker.

(2) The signal processing apparatus according to (1) above, wherein the target position setting unit sets a target angle of the virtual speaker, based on a difference between an ideal target angle of the real speaker and an actual angle of the real speaker.

(3) The signal processing apparatus according to (2) above, wherein: the real speaker is a surround speaker; the target position setting unit uses a first threshold value that is larger than the ideal target angle of the real speaker and smaller than a maximum value of the target angle of the virtual speaker, and a second threshold value that is larger than the maximum value of the target angle of the virtual speaker; the target position setting unit sets the ideal target angle of the real speaker as the target angle of the virtual speaker when the actual angle of the real speaker is smaller than or equal to the first threshold value; the target position setting unit sets the maximum value of the target angle of the virtual speaker as the target angle of the virtual speaker when the actual angle of the real speaker is larger than the second threshold value; and the target position setting unit sets a corresponding angle in a range larger than the ideal target angle of the real speaker and smaller than or equal to the maximum value of the target angle of the virtual speaker, as the target angle of the virtual speaker, when the actual angle of the real speaker is in a range larger than the first threshold value and smaller than or equal to the second threshold value.

(4) The signal processing apparatus according to (2) above, wherein: the real speaker is a front speaker; the target position setting unit uses a first threshold value that is smaller than the ideal target angle of the real speaker and larger than a minimum value of the target angle of the virtual speaker, and a second threshold value that is smaller than the minimum value of the target angle of the virtual speaker; the target position setting unit sets the ideal target angle of the real speaker as the target angle of the virtual speaker when the actual angle of the real speaker is larger than or equal to the first threshold value; the target position setting unit sets the minimum value of the target angle of the virtual speaker as the target angle of the virtual speaker when the actual angle of the real speaker is smaller than the second threshold value; and the target position setting unit sets a corresponding angle in a range smaller than the ideal target angle of the real speaker and larger than or equal to the minimum value of the target angle of the virtual speaker, as the target angle of the virtual speaker, when the actual angle of the real speaker is in a range smaller than the first threshold value and larger than or equal to the second threshold value.

(5) The signal processing apparatus according to any of (2) to (4) above, wherein the disposition control unit controls the disposition of the virtual speaker by distributing an audio signal of a channel associated with the real speaker to the real speaker and a speaker adjacent to the real speaker, according to the set target angle of the virtual speaker.

(6) The signal processing apparatus according to any of (1) to (5) above, wherein the arrangement position information acquisition unit acquires the arrangement position information on the real speaker by collecting a test signal fed from the real speaker with two microphones spaced at a fixed distance and processing it.

(7) A signal processing method including the steps of:

acquiring arrangement position information on a real speaker;

setting a target position of a virtual speaker corresponding to the real speaker, based on the acquired arrangement position information, such that the virtual speaker is disposed in or near an ideal disposition area of the real speaker; and

controlling the disposition of the virtual speaker, based on the set target position of the virtual speaker.

(8) A program for causing a computer to serve as:

an arrangement position information acquiring means for acquiring arrangement position information on a real speaker;

a target position setting means for setting a target position of a virtual speaker corresponding to the real speaker, based on the acquired arrangement position information, such that the virtual speaker is disposed in or near an ideal disposition area of the real speaker; and

a disposition controlling means for controlling the disposition of the virtual speaker, based on the set target position of the virtual speaker.

(9) A signal processing apparatus including:

an arrangement position information acquisition unit for acquiring an actual angle of a real speaker;

a target position setting unit for setting a target angle of a virtual speaker corresponding to the real speaker, based on a difference between an ideal target angle of the real speaker and the acquired actual angle of the real speaker; and

a disposition control unit for controlling the disposition of the virtual speaker, based on the set target angle of the virtual speaker.

(10) A signal processing apparatus including:

a signal distribution unit for distributing audio signals of a plurality of channels each to a speaker of an associated channel and a speaker of an adjacent channel;

a delay addition unit for adding delays to the audio signals to be fed to the speakers; and

a control unit for controlling operations of the signal distribution unit and the delay addition unit, based on information on actual arrangement positions of the speakers.

(11) The signal processing apparatus according to (10) above, wherein: the control unit sets a target angle of a virtual speaker corresponding to a speaker of a predetermined channel, based on a difference between an ideal target angle of the speaker of the predetermined channel and an actual angle of the speaker of the predetermined channel; and the control unit controls distribution of an audio signal of the channel associated with the speaker of the predetermined channel to the speaker of the predetermined channel and a speaker of an adjacent channel, according to the set target angle.

(12) The signal processing apparatus according to (10) or (11) above, further including an arrangement position information acquisition unit for acquiring the information on the actual arrangement positions of the speakers by collecting test signals fed from the speakers with two microphones spaced at a fixed distance and processing them.

(13) A signal processing method including:

distributing audio signals of a plurality of channels each to a speaker of an associated channel and a speaker of an adjacent channel;

adding delays to the audio signals to be fed to the speakers; and

controlling operations of the signal distribution and the delay addition, based on information on actual arrangement positions of the speakers.

(14) A speaker system including:

a plurality of speakers individually associated with a plurality of channels;

a signal distribution unit for distributing audio signals of the plurality of channels each to a speaker of an associated channel and a speaker of an adjacent channel;

a delay addition unit for adding delays to the audio signals to be fed to the plurality of speakers; and

a control unit for controlling operations of the signal distribution unit and the delay addition unit, based on information on actual arrangement positions of the plurality of speakers.

### REFERENCE SIGNS LIST

10 Multichannel reproduction system
100 Audio signal output device
210 Decoder
220 DSP
230, 240-1, 240-2 Amplifier
300 Speaker
400-1, 400-2 Microphone
501 Controller
502 Test signal memory
503 Acoustic adjustment parameter memory
504 Response signal memory
505 Internal data bus
601 Controller
602 Acoustic adjustment parameter memory
621, 631, 641, 651 Signal distribution unit
622, 632, 642, 652 Synthesis unit
613, 623, 633, 643, 653 Filter
614, 624, 634, 644, 654 Delay memory

1. A signal processing apparatus comprising:
an arrangement position information acquisition unit for acquiring arrangement position information on a real speaker;
a target position setting unit for setting a target position of a virtual speaker corresponding to the real speaker, based on the acquired arrangement position information, such that the virtual speaker is disposed in or near an ideal disposition area of the real speaker; and
a disposition control unit for controlling the disposition of the virtual speaker, based on the set target position of the virtual speaker.

2. The signal processing apparatus according to claim 1, wherein the target position setting unit sets a target angle of the virtual speaker, based on a difference between an ideal target angle of the real speaker and an actual angle of the real speaker.

3. The signal processing apparatus according to claim 2, wherein:
the real speaker is a surround speaker;
the target position setting unit uses a first threshold value that is larger than the ideal target angle of the real speaker and smaller than a maximum value of the target angle of the virtual speaker, and a second threshold value that is larger than the maximum value of the target angle of the virtual speaker;
the target position setting unit sets the ideal target angle of the real speaker as the target angle of the virtual speaker when the actual angle of the real speaker is smaller than or equal to the first threshold value;
the target position setting unit sets the maximum value of the target angle of the virtual speaker as the target angle of the virtual speaker when the actual angle of the real speaker is larger than the second threshold value; and
the target position setting unit sets a corresponding angle in a range larger than the ideal target angle of the real speaker and smaller than or equal to the maximum value of the target angle of the virtual speaker, as the target angle of the virtual speaker, when the actual angle of the real speaker is in a range larger than the first threshold value and smaller than or equal to the second threshold value.

4. The signal processing apparatus according to claim 2, wherein:
the real speaker is a front speaker;
the target position setting unit uses a first threshold value that is smaller than the ideal target angle of the real speaker and larger than a minimum value of the target angle of the virtual speaker, and a second threshold value that is smaller than the minimum value of the target angle of the virtual speaker;
the target position setting unit sets the ideal target angle of the real speaker as the target angle of the virtual speaker when the actual angle of the real speaker is larger than or equal to the first threshold value;
the target position setting unit sets the minimum value of the target angle of the virtual speaker as the target angle of the virtual speaker when the actual angle of the real speaker is smaller than the second threshold value; and
the target position setting unit sets a corresponding angle in a range smaller than the ideal target angle of the real speaker and larger than or equal to the minimum value of the target angle of the virtual speaker, as the target angle of the virtual speaker, when the actual angle of the real speaker is in a range smaller than the first threshold value and larger than or equal to the second threshold value.

5. The signal processing apparatus according to claim 2, wherein the disposition control unit controls the disposition of the virtual speaker by distributing an audio signal of a channel associated with the real speaker to the real speaker and a speaker adjacent to the real speaker, according to the set target angle of the virtual speaker.

6. The signal processing apparatus according to claim 1, wherein the arrangement position information acquisition unit acquires the arrangement position information on the real speaker by collecting a test signal fed from the real speaker with two microphones spaced at a fixed distance and processing it.

7. A signal processing method comprising the steps of:
acquiring arrangement position information on a real speaker;
setting a target position of a virtual speaker corresponding to the real speaker, based on the acquired arrangement position information, such that the virtual speaker is disposed in or near an ideal disposition area of the real speaker; and
controlling the disposition of the virtual speaker, based on the set target position of the virtual speaker.

8. A program for causing a computer to serve as:
an arrangement position information acquiring means for acquiring arrangement position information on a real speaker;
a target position setting means for setting a target position of a virtual speaker corresponding to the real speaker, based on the acquired arrangement position information, such that the virtual speaker is disposed in or near an ideal disposition area of the real speaker; and
a disposition controlling means for controlling the disposition of the virtual speaker, based on the set target position of the virtual speaker.

9. A signal processing apparatus comprising:
an arrangement position information acquisition unit for acquiring an actual angle of a real speaker;
a target position setting unit for setting a target angle of a virtual speaker corresponding to the real speaker, based on a difference between an ideal target angle of the real speaker and the acquired actual angle of the real speaker; and
a disposition control unit for controlling the disposition of the virtual speaker, based on the set target angle of the virtual speaker.

10. A signal processing apparatus comprising:
a signal distribution unit for distributing audio signals of a plurality of channels each to a speaker of an associated channel and a speaker of an adjacent channel;
a delay addition unit for adding delays to the audio signals to be fed to the speakers; and
a control unit for controlling operations of the signal distribution unit and the delay addition unit, based on information on actual arrangement positions of the speakers.

11. The signal processing apparatus according to claim 10, wherein:
the control unit sets a target angle of a virtual speaker corresponding to a speaker of a predetermined channel, based on a difference between an ideal target angle of the speaker of the predetermined channel and an actual angle of the speaker of the predetermined channel; and
the control unit controls distribution of an audio signal of the channel associated with the speaker of the predetermined channel to the speaker of the predetermined channel and a speaker of an adjacent channel, according to the set target angle.

12. The signal processing apparatus according to claim 10, further comprising an arrangement position information acquisition unit for acquiring the information on the actual arrangement positions of the speakers by collecting test signals fed from the speakers with two microphones spaced at a fixed distance and processing them.

13. A signal processing method comprising:
distributing audio signals of a plurality of channels each to a speaker of an associated channel and a speaker of an adjacent channel;
adding delays to the audio signals to be fed to the speakers; and
controlling operations of the signal distribution and the delay addition, based on information on actual arrangement positions of the speakers.

14. A speaker system comprising:
a plurality of speakers individually associated with a plurality of channels;
a signal distribution unit for distributing audio signals of the plurality of channels each to a speaker of an associated channel and a speaker of an adjacent channel;
a delay addition unit for adding delays to the audio signals to be fed to the plurality of speakers; and
a control unit for controlling operations of the signal distribution unit and the delay addition unit, based on information on actual arrangement positions of the plurality of speakers.
